(19) United States
(12) Patent Application Publication
(10) Pub. No.: US 2007/0193045 A1
(43) Pub. Date: Aug. 23, 2007

(54) Device and method for display of azimuthal and other information

(76) Inventors: Salim E. Kahil, Westcliff (GB); Susan M. Kahil, Westcliff (GB)

Correspondence Address: Salim E. Kahil, 3 South Drive, Westcliff, Southend-On-Sea, Essex, SSO 9PW, GB

(21) Appl. No.: 11/359,125

(22) Filed: Feb. 21, 2006

(51) Int. Cl. G01C 17/00

(52) U.S. Cl. 33/355 R

(57) ABSTRACT

Embodiments of the inventive display device for indicating of azimuthal and other information are provided, comprising at least one preferably circular configuration of light emitting elements, control unit, magnetic sensor. An imaginable straight line, extending from the device display's center to an actuated element, determines azimuthal direction. One uniquely shaped element is actuated when the device is oriented towards the north magnetic pole by said imaginable line extending through said unique element. When the device's orientation changes, said unique element is de-actuated. A user, by regulating means, may preset a desirable direction by actuating an element coincided with the direction. The device is capable to “remember” the direction; when its orientation changes, another element is actuated, still showing the desirable direction. Some embodiments of the device may exhibit timepiece, calendar, temperature and other information. Azimuthal information may be displayed in a predetermined color position order of the light emitting elements.

### BACKGROUND OF THE INVENTION

The present invention relates to information display devices and methods, more particular, relates to display of azimuthal direction information alone, and also in combinations with temperature, time, calendar and other information.

Azimuthal direction devices (e.g. solar compass, gyrocompass) are known and widely utilized. Probably the most broadly known device of such kind is a magnetic compass. A conventional magnetic compass generally has a pivotally mounted magnetic hand freely positioned in the natural magnetic field of the earth, so that one end of the hand, having the north magnetic polarity, is oriented to the north, and the second end, having the south magnetic polarity, is oriented to the south. A limb, usually having the north (N), south (S), west (W), and east (E) markings, is disposed essentially horizontally and perpendicularly to the pivotal axis, so that the magnetic hand allows to indicate a magnetic orientation if the limb is turned in such a way that the N-marking substantially coincides with the hand's end having the north polarity.

A display device, disclosed in U.S. Pat. No. 4,041,692 to Marshino, teaches “an improved solid state electronic clock having a time indicating light display provided by a plurality of LEDs positioned in three concentric rings to separately indicate hours, minutes, and seconds. Multi-stage counters enable the use of a 6.times.10 LED matrix for the separate indication of minutes and seconds, while a 1.times.12 LED matrix indicates the hour. The circuitry utilizes a 60 hertz input and holds the second indication while enabling rapid advancement of the minute and hour indications for setting the clock. In addition, a light simulated pendulum may also be provided”. The invention does not however deal with indicating of azimuthal information.

A timepiece display, according to U.S. Pat. No. 5,896,348 to Lyon, “may include first, second and third groups of indicators where each indicator can exhibit one of two states and can be switched to exhibit either of the two states. The amount of indicators of the first group exhibiting one of the two states indicates an elapsed number of hours. The amount of indicators of the second group exhibiting one of the two states indicates an elapsed number of minutes in multiples of ten. The amount of indicators of the third group exhibiting one of the two states indicates an elapsed number of minutes. Accordingly, the first, second and third groups of indicators, taken together, indicate a time of day.” It does not teach or suggest how to use the display for determination of earth magnetic directions.

UK patent GB2204429B to Salim E. Kahil and Susan M. Kahil, hereby incorporated by reference in its entirety, discloses a timepiece display comprising “a number of concentrically arranged circles of light emitting elements representing hour, minutes and seconds, each hour, each minute, and each second being represented by an individual element, the light emitting elements being individually actuable such that an instant in time is displayed by actuating only one hour representing element, one minute representing element, and one second representing element, and wherein the colour of the light emitting elements varies around the circles.” Said timepiece display is incapable to display azimuthal information.

U.S. design patent D495,966 to Susan M. Kahil and Salim E. Kahil basically provides an exemplary appearance of a timepiece similar to the one described above in the UK patent GB2204429B.

The prior art presents a vast variety of magnetic compasses, mostly in combinations with timepieces. For example, U.S. Pat. No. 5,883,861 to Moser, et al teaches how to build a timepiece comprising an electronic compass and a sighting device to position the compass in a needed direction. Following is a brief description of such a device.

An electronic compass includes a permanent magnet, mounted so as to rotate freely within a case, and two electromagnetic sensors known to those skilled in the art and offset angularly by 90.degree. in relation to the axis of rotation of the permanent magnet. The two electromagnetic sensors supply an electric signal to an electronic unit arranged for processing the electric signals received from the electromagnetic sensors so as to determine accurately the direction of the magnetic axis of permanent magnet in the general plane of the case. The electromagnetic sensors are attached to the case. The electronic unit can determine, via processing known to those skilled in the art, the azimuthal orientation of a reference axis defined by two diametrically opposite marks of a sighting device. For determining the azimuthal orientation of the case and for performing a sighting via the sighting device, the general plane of the case is preferably horizontal.

The electronic compass includes alarm means, controlled by said electronic unit, for providing at least one signal perceptible to a user of said timepiece when he performs a sighting by means of the sighting device, said electronic unit being arranged so that the signal is provided to the user when said reference axis is aligned with the selected azimuthal orientation.

In an embodiment of that invention, the alarm means, used to indicate to the user performing a sighting when the reference axis defined by the sighting device, is aligned with a selected azimuthal direction, are formed by electrically activated optical means. In the example given for this embodiment, these optical means are formed by three light emitting diodes: left, central, and right, arranged on the surface of the case, more particularly on an external upper surface of the case's middle part in a region situated at 6 o'clock. Thus, when a user performs a sighting, the user can see the diodes without any problem and perceive one or more optical signals provided by said diodes. Said electronic unit is electrically connected to a power supply for the diodes. The diodes can be used in various ways according to various alternatives to warn or inform the user of the fact that the reference axis defined by the sighting device is aligned or not aligned with a selected azimuthal direction.

For example, when the user has to rotate the case in an anti-clockwise direction, the left diode is activated and provides a light signal. Conversely, when the case has to be rotated in the clockwise direction, it is the right diode, which provides a light signal. Once the reference axis is aligned with the selected azimuthal direction, the central diode is activated and provides a light signal, or it is possible for all three diodes to be activated. In another alternative, it is even possible for the signal provided by the diodes to consist of an absence of light transmission, when the reference axis is properly aligned with the selected direction. The diodes may be different colors, for example, the left and right diodes may be red, while the central diode is green. The U.S. Pat. No. 5,883,861 is hereby entirely incorporated by reference.

U.S. Pat. No. 4,077,032 to Volkman, which is also incorporated by reference into this application, teaches “electronic display apparatus simulating a mechanical analog display for the portrayal of two or more measured variables includes an indicator assembly having a substrate supporting a plurality of optically variable elements, combinations of which enable the visual presentation of the measured parameters relative to a fixed scale or to each other. The apparatus is especially well suited for use as the time display of an electronic horological instrument. The display apparatus is electronically driven and includes no moving parts.” One of the embodiments of that electronic display includes an option for viewing of compass readings.

Another U.S. Pat. No. 5,600,611 to Kamens, also hereby entirely incorporated by reference, teaches a wrist mountable compass capable of directing a user to a selected compass direction. In the preferred embodiment of the compass, the user selects a compass direction. The user is directed to the selected direction by digital pointers appearing on the compass. The compass utilizes a single magnetoresistive sensor to sense the polarity of the horizontal flux lines of the earth's magnetic field.

Some prior art solutions propose alternative ways of azimuthal information displaying. In particular, U.S. Pat. No. 6,580,663 to Whitmore teaches “the directional indicators, such as East, South, West, North, are preferably arranged on display surface . . . in an inverted orientation relative to a conventional compass, so as to represent the viewing of the heavenly bodies from a position wherein one lies on the ground looking skyward with his or her head pointing to the North, as opposed to the directional indicators found on a conventional directional compass which are structured for travel over the earth's surface.”

Therefore, there is a need for unobtrusive alternative means for azimuthal information display suitable for people of different individuality, character, culture, education, life style, etc. In some instances, communication of information does not necessarily involve knowledge of or necessity in exact amounts, or an extensive exchange of information. Sometimes it is more important to create a fresh feeling, a positive emotion, or to appeal to intuitive sensations. There are some known examples of such modem ambient products, e.g. an illumination device made of frosted glass providing information on stock portfolio, health, and weather by slow changes of colors of its lights.

While the structural arrangements of the above described and many other devices, at first appearance, have similarities with the present invention, they differ in material respects. These differences are essential for the use of the present invention.

It is therefore an aim of the invention to provide a novel and useful display device for displaying of azimuthal and other similar information. Another aim is to provide a method of unconventional displaying such azimuthal and other similar information, suitable for the above-mentioned purposes. Other aims of the invention might become apparent to a skilled artisan from a consideration of the drawings, ensuing description, and claims as hereinafter related.

### BRIEF SUMMARY OF THE INVENTION

In accordance with the above mentioned aims, the present invention provides a display device for indicating of azimuthal directions. The display comprises at least one preferably circular configuration of light emitting elements, preferably LEDs. An azimuthal direction is determined by an imaginable straight line extending from the center of device's display to an at least one actuated (lighted up) element of at least one of said configurations.

One element of said at least one configuration is preferably uniquely shaped, and is actuated when the device is oriented towards the north magnetic pole by said imaginable line extending through the uniquely shaped element. When the orientation of the device changes, the uniquely shaped element is de-actuated. A user by a regulating means may preset a direction by lighting up an element, wherein said imaginable line extending through that element is coincided with the desirable direction. The device is capable to “remember” the direction, and when the user changes the device's orientation, another lighting element (generally of different color) will be actuated, but still oriented towards the preset direction.

### BRIEF DESCRIPTION OF THE DRAWINGS

FIG. 1 is a view of the display device having one circle of 12 light emitting elements with certain color position order, wherein all the elements are depicted actuated (switched on) for demonstration purposes.

FIG. 2 is a view of the display device having three concentric circles of 12 light emitting elements with certain color position order, wherein all the elements are depicted actuated for demonstration purposes.

FIG. 3 is a view of the display device having three concentric circles of 12 light emitting elements, wherein only one element of each circle is illustrated actuated exemplarily showing an imaginable direction coinciding with a north magnetic orientation.

FIG. 4 is a view of the display device having one circle of 24 light emitting elements with certain color position order, wherein all the elements are indicated by reference numerals, and depicted actuated for demonstration purposes.

FIG. 5 is a view of the display device illustrating an actuated triangle-like light emitting element showing the north (N) orientation and another light emitting element actuated by a user.

FIG. 6 is a view of the display device illustrating the light emitting element remained actuated after the device has been turned by the user.

FIG. 7 is a view of the display device illustrating configurations of light emitting elements for a combined display indicating the azimuthal and time information.

### DESCRIPTION OF PREFERRED EMBODIMENTS OF THE INVENTION

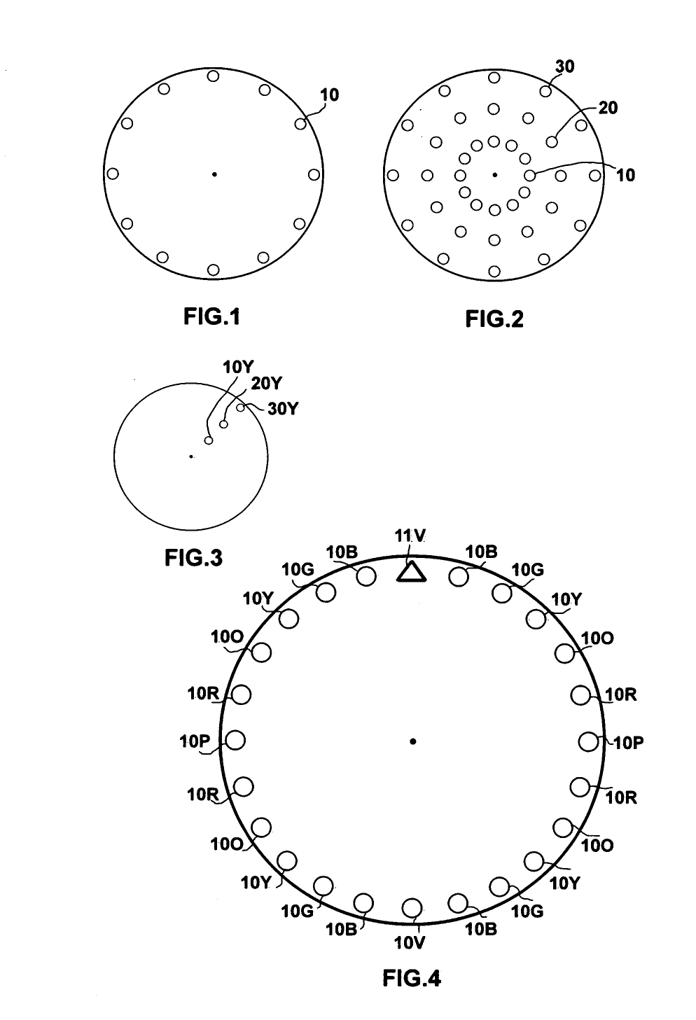

The aforesaid aims of the present invention are achieved by providing a display device, exemplarily shown on FIG. 1, preferably with a concentric configuration of twelve light emitting elements (10) positioned on the face of the display device, controlled by a control unit (not shown herein), operably similar to those described in the above mentioned prior art documents incorporated herein by reference.

Each of the light emitting elements of the embodiment has a certain color, and they are disposed on the configuration according to a certain color position order discussed below. Being positioned in a substantially horizontal plane, the display device may show a magnetic orientation in given location by actuating (or switching on) one of the light emitting elements of said configuration, whereas an imaginable straight line, extended from the center of said configuration to the light emitting element being actuated, essentially coincides with said magnetic orientation.

This may be achieved by implementing a magnetic sensor (not shown herein, but conventionally known to those skilled in the art) associated, for example, with said control unit. The control unit may actuate the light emitting element essentially disposed on the configuration in the direction from the center of display device to a desirable magnetic orientation.

The light emitting elements each may preferably be implemented by at least one solid state light emitting diode (LED) of a certain color, nowadays widely utilized for such purposes. Of course, other suitable types of light sources may be used as necessary. A light emitting element may optionally be placed in the center of the display device to help the user determining the center of display where said imaginable straight line is extended from.

In another embodiment, the display device may include a plurality of such concentric configurations, so that the magnetic orientation may be pictured by actuating of a plurality of light emitting elements (exemplary twelve such elements for each concentric configuration are illustrated on FIG. 2). Each said actuated element pertains to one of the concentric configurations and also pertains to an imaginable straight line, extended from the center of said configuration to the most outward light emitting element being actuated, which line essentially coincides with said magnetic orientation. FIG. 3 shows three actuated yellow elements (1Y), (2Y), (3Y) of three exemplary concentric configurations. These three actuated elements show the direction of the imaginable straight line.

Another preferable feature of the display device is said color position order. The inventive display device according to an embodiment may have 24 light emitting elements disposed, as depicted on FIG. 4, on a concentric configuration in the following color position order (in the clock-wise direction, starting from the 12 o'clock position): violet (11V), blue (10B), green (10G), yellow (10Y), orange (10O), red (10R), pink (10P), red (10R), orange (10O), yellow (10Y), green (10G), blue (10B), violet (10V), blue (10B), green (10G), yellow (10Y), orange (10O), red (10R), pink (10P), red (10R), orange (10O), yellow (10Y), green (10G), blue (10B). It can be noticed, that the color position order essentially corresponds to the well-known order of the natural sunlight spectrum. The violet element 11V should be uniquely shaped. In this embodiment it is implemented in a triangle-like shape, as shown on FIG. 4.

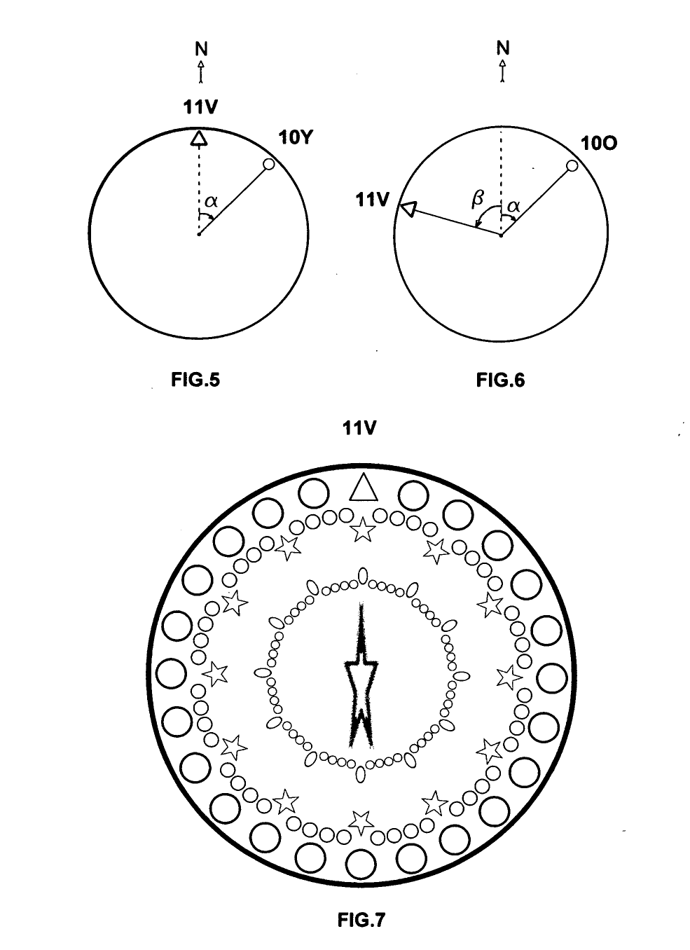

In order to indicate the north magnetic orientation, the actuation of the light emitting elements may be so arranged that when, for example, the 12 o'clock positioned violet light emitting element 11V is actuated (implemented in a triangle-like shape, as illustrated on FIG. 5), said imaginable straight line (shown by a dashed line on FIG. 5), extended from the center of said configuration to the actuated element 11V, is essentially directed towards the north magnetic pole (shown by an arrow pointed to N on FIG. 5).

Of course, if the device, being substantially in the horizontal plane, is turned, for instance, at an angle “beta” counter clock-wise, element 11V will be de-actuated (or switched off), and another element with a different color will be actuated (e.g. element 10O shown on FIG. 6). This will provide a user with the north magnetic orientation in the new position of the device.

However, the user would be aware, if he/she wants to determine the N (north), E (east), S (south), W (west) magnetic directions in given location, the device should be so positioned that the uniquely shaped light emitting element should be lighted up (actuated). In that position, the uniquely shaped element will show the N-orientation, the opposite direction will be the S-orientation, perpendicularly to the right from the N-orientation will be the E-orientation, and perpendicularly to the left from the N-orientation will be the W-orientation.

In some embodiments, a regulating means, e.g. a conventional knob (not shown) may be mounted on the casing (not shown) of the display device to allow selecting and setting a desirable direction (e.g. north-east directed at an “alpha” angle clock-wise) while the element 11V is actuated, as illustrated on FIG. 5. In an embodiment, the user selects a direction by turning the knob, and then presets the direction, for example, by pushing the knob in and fixing it. The exemplarily selected element 10Y (on FIG. 5) showing the north-east direction will remain actuated, if the device will further be in the same orientation.

When the user changes the orientation of the display device (illustrated on FIG. 6), the control unit will de-actuate the 11V and 10Y elements, and actuate another element, e.g. 10O (as depicted on FIG. 6), that will show the actual north-east direction in the newly oriented position of the display device. This can, for instance, be implemented by using a magnetic sensor (not shown), sensing the north orientation, in conjunction with said control device using information about said “alpha” angle, kept in memory. In this example, the control unit will actuate element 10O, which will be positioned at the “alpha” angle clock-wise from the actual north magnetic orientation (see FIG. 6), that is in the desirable north-east direction.

Therefore, if the user registers an alteration of color of an actuated light emitting element, this means that the device is signaling that it has been turned. Conversely, in other embodiments, if another element is actuated by the control unit in addition to the already actuated by the user element, it may “suggest” changing the current direction to the earlier preset direction. Such “suggestions” might be based on an internal program, or on external control commands, or both. It could be used in situation when the user might not be able to see the surrounding environment or might not notice the turn of the device. The signal may optionally be provided as a sound, alerting the user about the changing of the direction. This may be utilized particularly for real orientation (e.g. in deep water) or for entertainment (e.g. game) purposes. Different means of adjustment of magnetic orientations to the actual geographical N, S, W, E directions (including the sun's positions), known from the prior art, may be implemented in the display device.

Many other features, besides those described herein above, may be utilized in the inventive device. The display device can be encapsulated in a traditional wrist mountable casing. Alternatively, it can be encapsulated in or integrated into other devices. Such encapsulation or integration should be apparent to those skilled in the art. Particularly, it could also be possible to integrate such a display device, for instance, into a cellular phone, PDA, laptop computer, camera, or another device having a visual monitor means.

The desirable direction information (including, e.g. GPS information) may optionally be entered into the control unit via various data input means, using, for example, the BlueTooth, WiFi, RF, IR, and other types of communication channels. Therefore, it can be an alternative to the use of magnetic sensors, supplying the magnetic orientation information to the display device in the above-described embodiments.

Utilizing the Inventive Device for Display of Other Information

The display device may also be additionally used for display of current time, outside temperature, calendar, for setting alarm signals or timer actions, etc. For instance, FIG. 7 shows four concentric circle configurations of light emitting elements, wherein the most outward circle is utilized for indication of azimuthal information, as discussed above. The other three circles of light emitting elements can be used for indication of the current time as disclosed in UK patent GB2204429B (hours, minutes, seconds), entirely incorporated into this description.

The multi-color configuration illustrated on FIG. 4 used for displaying of azimuthal directions, may be used for exhibition of time information by changing a “compass mode” to a “timepiece mode”. For this purpose, the same (i.e. aforesaid knob) or a different regulating means (second knob, timer means, voice or light activation means, etc.) for selection and activation of various device modes (e.g. by switching from a “compass mode” to a “timepiece mode”, or to a “compass and timepiece mode”, etc.), may be implemented.

Obviously, another suitable type of timepiece with conventional numerical or another design (for example, including Zodiac symbols, etc.) may be utilized in combination with the disclosed azimuthal information display as well.

An “alarm mode”, “timer mode”, and the like might be also implemented in the display device. Using a regulating means (the knob, or another means), the user should be able to preset a desirable time for an alarm signal (“alarm mode”). A conventional alarm sound means or alarm light means may be incorporated into the display device in such a case. The “timer mode” may be needed, e.g. for automatic actuation or de-actuation of the “compass and timepiece mode”, a “night illumination mode”, or for another purpose.

Calendar information, such as “current date”, also may be exhibited by the display device using light emitting elements in a “calendar mode”. The “seven days of a week” information may be shown by elements of different colors on a separate “calendar” circle configuration, or using the “azimuthal” or “timepiece” circles in a separate “day-of-week mode”. For this purpose, a conventional electronic calendar means, known to a skilled artisan, may be implemented and associated with the control unit. The current date and the day of the week may alternatively be exhibited in a conventional format, for example in a place between some other circle configurations, or in the center of the display.

The outside temperature can be measured by a thermal sensor (not shown) implemented in the display device and associated with the control unit. The temperature, for example, in degrees of the Fahrenheit scale (or alternatively of the Celsius or another scale) may be indicated by additional circles of light emitting elements of different colors (not shown herein). For instance, 90F may be indicated by bigger violet elements, 91F, 92F, etc. by smaller violet elements. Likewise, 80F, 81F, etc. may be implemented by blue elements; 70F, 71F, etc. by green elements, and so on.

The light emitting elements indicating temperature may be implemented, for example in a hexagonal (or another suitable) shape, distinguishable from the elements showing the azimuthal or time information. The above-mentioned knob or another regulating means may be utilized for changing a “compass mode”, or a “timepiece mode”, or a “compass and timepiece mode” to a “temperature mode” (or “temperature and timepiece mode”, etc.). The temperature information may alternatively be exhibited in a conventional numeral format in a convenient place of the device's display.

While the invention may be susceptible to embodiment in different forms, there are shown in the drawings, and are described in detail herein above, specific embodiments of the present invention, with the understanding that the present disclosure is to be considered an exemplification of the principles of the invention, and is not intended to limit the invention to that as illustrated and described herein.

We claim:

1. A device for display of information comprising
a plurality of light emitting elements arranged into a number of configurations positioned on the face of the device; and
control means for actuation and de-actuation of the light emitting elements.

2. The device according to claim 1 wherein
the control means comprising
a control unit configured to process an internal program, or an external command, or a combination thereof, and to actuate and de-actuate the light emitting elements; and
a magnetic sensor capable to determine a magnetic orientation of the device in the earth magnetic field, said sensor associated with said control unit.

3. The device according to claim 1 wherein
the light emitting elements each comprising at least one light emitting diode.

4. The device according to claim 1 wherein
the light emitting elements performed of several colors, and
the light emitting elements disposed in a predetermined color position order along each of said number of configurations.

5. The device according to claim 1 wherein
said number of configurations positioned concentrically on the face of the device.

6. The device according to claim 5 further comprising
at least one light emitting element arranged in the center of said configurations.

7. The device according to claim 1 further comprising
a regulating means particularly enabling a user to select and preset a desirable orientation of the device; the regulating means associated with said control means.

8. The device according to claim 7 wherein
the control means comprising
a control unit configured to process at least one internal program or one external command, or to keep in memory and process at least one user preset orientation, or a combination thereof, to actuate and de-actuate the light emitting elements according to the output of the processing; and
a magnetic sensor capable to determine a magnetic orientation of the device in the earth magnetic field, said sensor associated with said control unit.

9. The device according to claim 8 further comprising at least one of the following:
a timepiece means capable to indicate current time, and configured to be activated in a timepiece mode;
a calendar means capable to indicate a current date or a day of week, and configured to be activated respectively in a calendar mode or in a day of week mode;
a temperature sensor means capable to indicate outside current temperature, and configured to be activated in a temperature mode;
any combination of the above enumerated means;
wherein said regulating means particularly enabling a user to select and activate said modes of the device; said control means configured to actuate said light emitting elements enabling them to exhibit information of the current time, current date, day of week, and outside current temperature on the face of the device, depending on activation of a mode chosen from said modes enumerated above.

10. The device according to claim 1 further configured for encapsulation into a wrist mountable casing.

11. The device according to claim 1 further configured for integration into a cellular telephone, laptop computer, PDA, camera, or another device containing a visual monitor means.

12. The device according to claim 1 further configured for input of azimuthal and other information by means of BlueTooth, or WiFi, or RF, or IR communication channels, or any combination thereof.

13. A method for display of information comprising the acts of
providing a plurality of light emitting elements arranged into a number of configurations positioned on the face of the device;
providing control means for actuation and de-actuation of the light emitting elements, said control means associated with said light emitting elements;
providing said control means with instructions on actuating predetermined patterns of said light emitting elements in response to predetermined input information;
entering input information into said control means;
displaying the input information by actuating the patterns of the light emitting elements responsive to the input information.

14. The method according to claim 13, wherein
the input information comprises
orientation information about an instant orientation of the device in the earth's magnetic field, and
desirable direction information about a user's desirable direction in the earth's magnetic field, in relation with said orientation information; and
the pattern of the light emitting elements actuated so that indicating essentially the same desirable direction information independent on the successive instant orientations of the device.
